(19) United States
(12) Patent Application Publication
(10) Pub. No.: US 2017/0327017 A1
(43) Pub. Date: Nov. 16, 2017

(54) SEAT

(71) Applicant: TACHI-S CO., LTD., Tokyo (JP)

(72) Inventors: Takahiko NAGASAWA, Tokyo (JP); Tsutomu FUJIKAKE, Tokyo (JP); Ryo KUROBE, Tokyo (JP)

(73) Assignee: TACHI-S CO., LTD., Tokyo (JP)

(21) Appl. No.: 15/529,900

(22) PCT Filed: Nov. 17, 2015
(86) PCT No.: PCT/JP2015/082238

§ 371 Date: May 25, 2017

(30) Foreign Application Priority Data
Nov. 26, 2014 (JP) 2014-239355

(51) Int. Cl. B60N 2/60; A47C 31/10; B60R 7/04; B60N 2/00; A47C 31/00

(52) U.S. Cl. CPC B60N 2/60; A47C 31/10; B60R 7/043; A47C 31/00; B60N 2/00

(57) ABSTRACT

The present invention provides a seat which reduces the load applied to a first fastening part, is unlikely to cause wrinkles or slack in a surface cover, and makes surface sheet attachment and detachment simple. To this end, a first fastening part and a second fastening part of a seat are attachable and detachable; hence, it is possible to easily exchange a surface cover according to the season and to clean the surface cover. The second fastening part attachably/detachably connects the surface cover and the rear-surface cover to one another. As a result, the second fastening part appropriately reduces the load directly applied to the first fastening part, making it possible to prevent damage to the first fastening part, and making it unlikely for wrinkles or slack to occur in the surface cover. Furthermore, the second fastening part is the same color and hue at each suspended section; hence, aligning the surface sheet position is easy.

### TECHNICAL FIELD

The present invention relates to a seat having a surface cover detachable from a back-side cover.

### BACKGROUND ART

Conventionally, as a technique in such a field, there is Japanese Examined Utility Model No. Hei4(1992)-39747. A seat described in this publication includes a foam cushioning material molded in a seat shape, a bag-like sheath covering the cushioning material and fixed to the cushioning material, a first cover covering the front side of the sheath, a second cover covering the back side of the sheath, and a slide fastener coupling the first cover to the second cover. The slide fastener is disposed on the side surface of the seat back, and hence strange and uncomfortable feelings are eliminated when a person sits on the seat.

### CITATION LIST

### Patent Literature

PTL 1: Japanese Examined Utility Model No. Hei4(1992)-39747

### SUMMARY OF INVENTION

### Technical Problem

However, the edge portion of the surface cover is only detachably provided to the edge portion of the back-side cover with the slide fastener. Thus, a problem arises in that when the back-side cover is tightly attached to the surface cover, a load is applied to the slide fastener, and this load causes the slide fastener to be broken or causes wrinkles and looseness on the surface cover.

A problem also arises in that in attaching the surface cover to the back-side cover, it is difficult how to assemble the slide fastener and a wrong order of assembly causes the covers to be improperly assembled with each other.

An object of the present invention is to provide a seat that reduces a load applied to a first fastener, is less prone to produce wrinkles or looseness on a surface cover, and easily assembles a surface cover.

### Solution to Problem

The present invention is a seat including: a surface cover and a back-side cover of a seat part; and a first fastener that detachably couples the surface cover to the back-side cover. In the seat, on a suspending part that suspends a part of the surface cover on a cushioning material, a second fastener that detachably couples the cushioning material to the surface cover is provided, and the second fastener is formed in an equal color or an equal pattern for individual suspending parts.

In this seat, since the first fastener and the second fastener are detachably provided, the surface cover can be easily replaced in seasons, or cleaned. The surface cover is coupled to the back-side cover with the detachable second fastener. As a result, the second fastener appropriately reduces a load directly applied to the first fastener. Thus, the first fastener is prevented from being damaged, and wrinkles or looseness are less prone to be produced on the surface cover. The second fastener is formed in an equal color or an equal pattern for the individual suspending parts. Hence, in attaching the surface cover, the second fastener is placed so that the color or pattern is matched at the individual suspending parts. Accordingly, the second fastener can be easily positioned at the individual suspending parts, and the assembly of the surface cover is simplified.

The detachable first fastener preferably includes a first fastening side part provided extending along the edge portion of the surface cover, and a second fastening side part provided extending along the edge portion of the back-side cover and detachably coupled to the first fastening side part.

The first fastener is preferably a line fastener, a hook-and-loop fastener, or a catchable hook unit, and the second fastener is preferably a line fastener or a hook-and-loop fastener.

The detachable second fastener preferably includes: a third fastening side part fixed to the cushioning material in a recess extending along the suspending part on the cushioning material; and a fourth fastening side part provided on the surface cover, stored in the recess, and detachably coupled to the third fastening side part.

With the adoption of such configurations, the second fastener is stored in the recess. Accordingly, the second fastener can be appropriately prevented from hitting the buttocks or back of a vehicle occupant at the suspending part.

### Advantageous Effects of Invention

According to the present invention, a load applied to the first fastener is reduced, wrinkles or looseness are less prone to be produced on the surface cover, and the front seat is easily attached and detached.

### BRIEF DESCRIPTION OF DRAWINGS

FIG. 1 is a perspective view of an embodiment of a seat according to the present invention.

FIG. 2 is a cross sectional view taken along line II-II in FIG. 1, which is an exploded perspective view of the seat.

FIG. 3 is an enlarged perspective view of the main components of a first fastener.

FIG. 4 is an enlarged perspective view of the main components of a second fastener.

FIG. 5 is an exploded perspective view of the seat.

### DESCRIPTION OF EMBODIMENTS

In the following, a preferred embodiment of a seat according to the present invention will be described in detail with reference to the drawings.

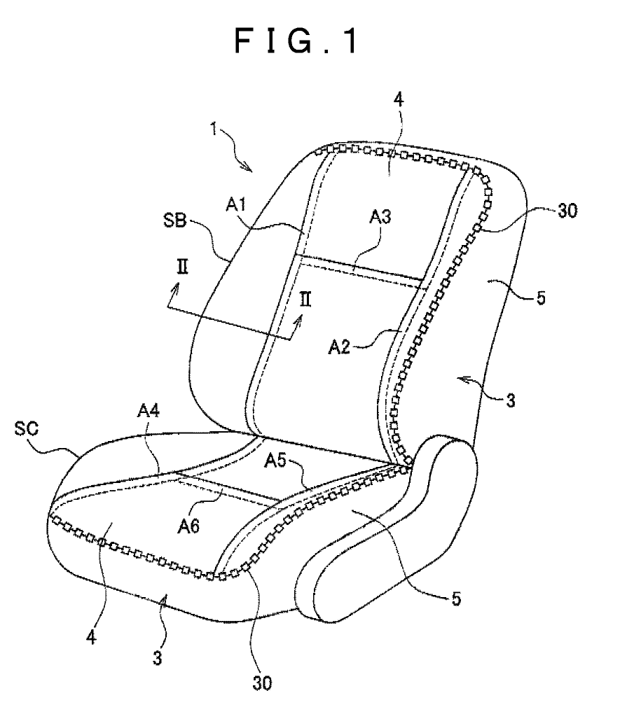

As shown in FIG. 1, a vehicle seat 1 includes a seat cushion (a seat part) SC movable fore and aft on a floor panel and a seat back (a seat part) SB reclinable to the seat cushion SC. The seat cushion SC and the seat back SB have a foam cushioning material 2, the surface of which is covered with a cover 3. The cover 3 is configured of a surface cover 4 and a back-side cover 5. The surface cover 4 is formed of separate parts so as to separately cover the cushioning material 2 for the seat cushion SC and the seat back SB.

In the seat 1, line-shaped suspending parts A1 to A6 are provided on the seat cushion SC and the seat back SB. The suspending parts A1 to A6 form the appearance of the seat 1 as well as prevent looseness or displacement of the cover 3.

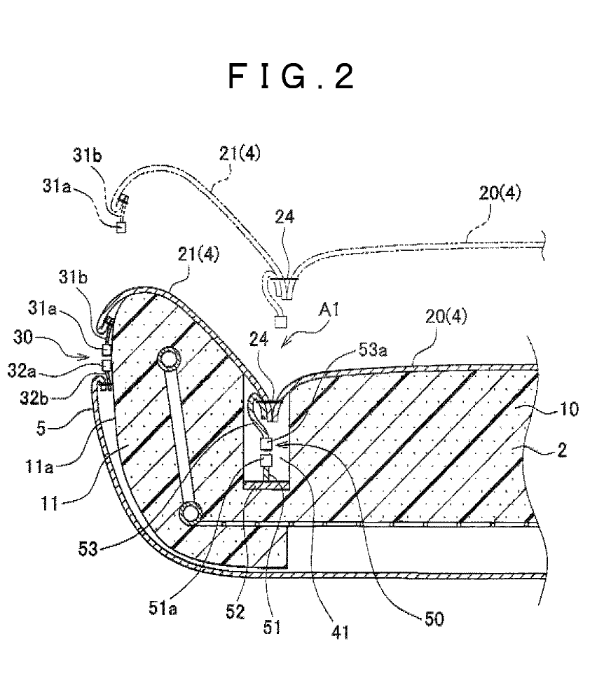

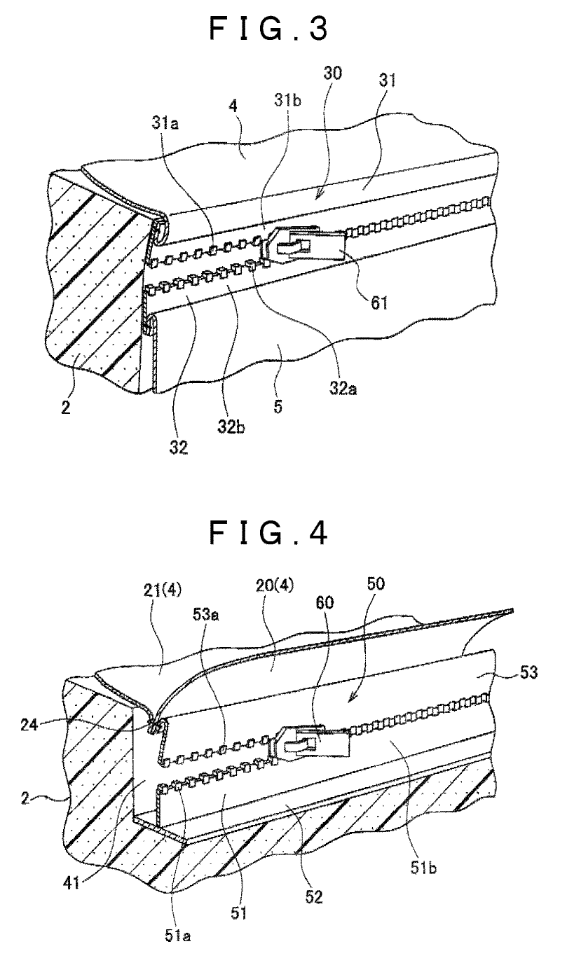

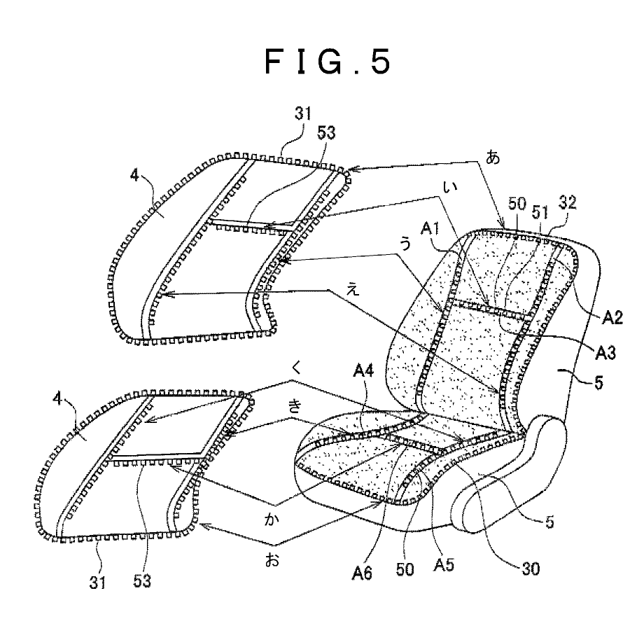

Here, the seat back SB is taken as an example and described. As shown in FIGS. 2 to 4, the cushioning material 2 of the seat back SB includes a main cushion 10 for supporting the back of a vehicle occupant from the rear side and a side cushion 11 for supporting the back of the vehicle occupant from the side.

On the other hand, the surface cover 4 is formed of a main face part 20 placed on the main cushion 10 of the cushioning material 2 and a side face part 21 placed on the side cushion 11. The main face part 20 is joined to the side face part 21 of the cover 3 with a seam 24. The surface cover 4 is coupled to the back-side cover 5 on an outer face 11a of the side cushion 11 with a first fastener 30.

The first fastener 30, which is detachable, has a first fastening side part 31 provided extending along the edge portion of the surface cover 4 and a second fastening side part 32 provided extending along the edge portion of the back-side cover 5 and detachably coupled to the first fastening side part 31. The first fastening side part 31 can be coupled to the second fastening side part 32 with a pull tab 61.

The first fastener 30 is configured of a line fastener. The first fastening side part 31 has a configuration in which teeth 31a referred to as elements are arranged on a tape-like base material 31b. Similarly, the second fastening side part 32 also has a configuration in which teeth 32a referred to as elements are arranged on a tape-like base material 32b. The base material 31b of the first fastening side part 31 is stitched at the rim of the surface cover 4, and the base material 32b of the second fastening side part 32 is stitched at the rim of the back-side cover 5.

The first fastener 30 is configured of a line fastener. However, the first fastener 30 is not limited to this, which may be a hook-and-loop fastener or a catchable hook unit.

Next, the suspending part A1 will be described.

The suspending part Al is provided with a second fastener 50 that detachably couples the cushioning material 2 to the surface cover 4. The detachable second fastener 50 has a third fastening side part 51 fixed to the cushioning material 2 in a recess 41 extending in the vertical direction along the suspending part A1 on the cushioning material 2, and a fourth fastening side part 53 provided on the surface cover 4, stored in the recess 41, and detachably coupled to the third fastening side part 51. The third fastening side part 51 can be coupled to the fourth fastening side part 53 with a pull tab 60. Note that, the recess 41 is formed along the boundary between the main cushion 10 and the side cushion 11 with a predetermined depth.

The second fastener 50 is configured as a line fastener. In this second fastener 50, the base end of a base material 51b of the third fastening side part 51 coupled to the fourth fastening side part 53 is adhered to a resin base 52 formed of a long flat plate. Note that, in the case in which the base material 51b is formed of a resin, the base material 51b may be integrally shaped so as to be erected in the center of the base 52. The bottom face of the base 52 is fixed to the bottom face of the recess 41 with an adhesive or double-sided tape. With the adoption of the base 52 in this structure, the third fastening side part 51 can be easily and reliably fixed to the cushioning material 2 using an adhesive or double-sided tape.

The fourth fastening side part 53 has a configuration in which teeth 53a referred to as elements are arranged. The third fastening side part 51 similarly has a configuration in which teeth 51a referred to as elements are arranged on the tape-like base material 51b.

The second fastener 50 at the suspending part A1 has the third fastening side part 51 and the fourth fastening side part 53 formed in the same color, red, for example. The second fastener 50 at the suspending part A2 has the third fastening side part 51 and the fourth fastening side part 5 formed in the same color, blue, for example. The second fastener 50 at the suspending part A3 has the third fastening side part 51 and the fourth fastening side part 53 formed in the same color, yellow, for example.

Note that, regarding the seat back SB, the suspending parts A2 and A3 (see FIG. 1) also have configurations equivalent to the configuration of the suspending part A1, omitting the description.

In the seat 1, the first fastener 30 of the seat back SB, the first fastener 30 of the seat cushion SC, and the second fasteners 50 at the suspending parts A1 to A6 on the seat back SB and the seat cushion SC are independent fastening, and the line fasteners of the fasteners 30 and 50 are provided with the pull tabs 60 and 61.

In the seat 1 in such a configuration, since the first fastener 30 and the second fastener 50 are detachably provided, the surface cover 4 can be easily replaced in seasons, or cleaned. The surface cover 4 is coupled to the back-side cover 5 with the detachable second fastener 50.

As a result, the second fastener 50 appropriately reduces a load directly applied to the first fastener 30. Thus, the first fastener 30 is prevented from being damaged, and wrinkles or looseness are less prone to be produced on the surface cover 4.

The second fastener 50 at the suspending part A1, the second fastener 50 at the suspending part A2, and the second fastener 50 at the suspending part A3 individually have the same colors at the suspending parts A1, A2, and A3. Thus, in attaching the surface cover 4, the surface cover 4 is placed so that the same colors are matched. Consequently, the second fasteners 50 can be easily positioned at the suspending parts A1 to A3, the third fastening side part 51 and the fourth fastening side part 53 of the second fastener 50 can be simply joined to each other at each suspending part, and the surface cover 4 can be easily attached.

The suspending parts A4, A5, and A6 of the seat cushion SC also have the configurations similar to the configurations of the suspending parts A1 to A3 of the seat back SB.

In the description above, the third fastening side part 51 and the fourth fastening side part 53 of the second fastener 50 are formed in the same color at the suspending parts A1 to A6. However, the configuration is not limited to this. The same patterns may be provided. Similarly to the case of the same color, the second fasteners 50 can be easily positioned at the suspending parts A1 to A6.

The seat according to the present invention can be used for automobile seats, aircraft seats, and seats for trains, buses, and passenger ships.

Note that, it is without saying that the present invention is not limited to the foregoing embodiment.

### REFERENCE SIGNS LIST

1: seat,

2: cushioning material

3: cover,

4: surface cover,

5: back-side cover,

30: first fastener,

31: first fastening side part,

32: second fastening side part,

50: second fastener,

51: third fastening side part,

53: fourth fastening side part,

A1 to A6: suspending part,

SB: seat back (seat part),

SC: seat cushion (seat part)

1. A seat comprising:
a surface cover and a back-side cover of a seat part; and
a first fastener that detachably couples the surface cover to the back-side cover,
wherein: on a suspending part that suspends a part of the surface cover on a cushioning material, a second fastener that detachably couples the cushioning material to the surface cover is provided; and
the second fastener is formed in an equal color or an equal pattern for individual suspending parts.

2. The seat according to claim 1,
wherein the first fastener is a line fastener, a hook-and-loop fastener, or a catchable hook unit.

3. The seat according to claim 1,
wherein the detachable second fastener includes:
a third fastening side part fixed to the cushioning material in a recess extending along the suspending part on the cushioning material; and
a fourth fastening side part provided on the surface cover, stored in the recess, and detachably coupled to the third fastening side part.

4. The seat according to claim 1,
wherein the second fastener is a line fastener or a hook-and-loop fastener.
